(19) United States
(12) Patent Application Publication
(10) Pub. No.: US 2005/0108041 A1
(43) Pub. Date: May 19, 2005

(54) Methods and systems for tracking lead information in a representative selling network

(76) Inventor: Lawrence W. White, Bryan, OH (US)

Correspondence Address: MORGAN LEWIS & BOCKIUS LLP, 1111 PENNSYLVANIA AVENUE NW, WASHINGTON, DC, 20004, US

(21) Appl. No.: 10/971,301

(22) Filed: Oct. 22, 2004

Related U.S. Application Data
(60) Provisional application No. 60/513,190, filed on Oct. 23, 2003.

(51) Int. Cl. G06F 7/00

(52) U.S. Cl. 705/1

(57) ABSTRACT

The present invention comprises systems and methods for tracking sales dead information. In one aspect, the invention comprises a system for tracking lead information related to a representative selling network, comprising: (a) means for acquiring and storing lead data relating to leads of a representative selling network; (b) means for registration of a member of the representative selling network; (c) means for enabling the member to search, tag, or be assigned the lead data; (d) means for enabling the member to post activity data relating to the leads; and (e) means for preparing reports based on the lead data and the activity data.

### CROSS-REFERENCE TO RELATED APPLICATIONS

This application claims the benefit of U.S. Provisional Application No. 60/513,190, filed Oct. 23, 2003. The entire contents of the above application are incorporated herein by reference.

### BACKGROUND

The following definitions are used herein:

Company—a company that produces goods or services and that uses a representative network. Companies could range from manufacturers to financial services providers to insurance companies.

Independent Representatives—representatives, independent of the company, that manage leads (representatives, customers or both) in a representative selling network. They typically are paid either on a commission basis or they purchase a product from a Company and resell to a customer. Independent representatives are often employed by agencies having multiple representatives working in a marketplace on behalf of a company or Companies Company representatives—representatives, usually employed by a company, that manage a network of representatives, customers or both in a representative selling network.

Lead—an account that is assigned to a representative to manage. The account may be for a customer, a representative, or any other sales assignment given to a representative.

Customer—a customer of the independent representative or company in a representative selling model.

Selling network—a team of company, independent representatives and/or company representatives that work together in the market to drive sales efforts at the customer.

Mixed selling model—a selling model that utilizes a combination of company and independent representatives.

Tagger—a person that tags or claims a lead—normally a representative.

Many Companies go to market using independent representatives because of their cost effectiveness and their unique value and reach to the market. Independent Representatives are used to support selling efforts and are used to call on customers, other representatives or both. Some companies use a mixed selling model comprised of both independent and company representatives. Companies typically sell or commission products and services to representatives who, in turn, represent those products in the market.

Companies that use a representative selling network often cite a lack of tracking, follow up and reporting by their representative partners when it comes to lead information. In the case when a representative purchases a product from a company and then resells it to a customer, it becomes virtually impossible for the company to track the representative's sales to customers.

Companies often claim that they cannot drive focused sales activity by their representatives and do not know what their representatives are doing or working on. They also claim that while representative agencies employ multiple representatives, they do not believe that all of the representatives are suitably focused on behalf of the company. They do not have an easy means for measuring the sales activity of the representative or for tracking critical marketing and sales information. They do not have a means for measuring whether the representatives are adequately covering the assigned market. They struggle to facilitate collaboration and information sharing between the entities of the representative selling network to meet the needs of their leads or customers.

Companies need information from their representatives to facilitate collaboration, to ascertain market coverage and market needs and to generally better serve their markets. This information helps a company to understand market potential, develop long term strategic direction, and to drive profits and growth.

In order to fully tap the potential of their representative network, companies need to focus their representatives on selling activity. This presents a challenge as representatives often represent other companies and are not easily tracked or held accountable to specific selling commitments.

Companies struggle to understand market coverage statistics from their representatives. Information regarding market coverage is typically anecdotal because of the lack of established market potential and clear coverage statistics on the representative.

The inability to collaborate with company and other representatives by sharing market and lead information such as testimonials, competitive information, and marketing information is another shortcoming of the representative selling model. Companies that can share marketing information are more likely to penetrate new leads and to capture higher profit margins by tailoring their sales pitch to the specific needs of the lead.

Companies often require a collaborative approach to selling through their representatives. An example would be when a company uses representatives to serve a given lead (customer or representative) with multiple locations. Because multiple representatives can be involved in such an example, inter-representative collaboration as well as coordination with the company is required to assure a consistent market approach.

Companies also require a collaborative sales approach in the case of “project” type sales. For example, a building construction project might follow a sequence of events that can involve multiple representatives during different phases of the project. Collaboration between entities is critical to serve the needs the lead, the representatives, and the company.

Companies that generate sales leads from promotional activity often struggle to drive follow up by their representatives. This is primarily due their inability to assign the leads to the appropriate representative and to create an easy means for generating feedback and follow up statistics. The ability to measure lead statistics is critical to ROI calculations on promotional investment.

Companies sometimes use sales promotions to drive revenue or market share growth. A shortcoming of most promotions is the inability to execute the program through a representative network. In addition, the documentation involved in many such promotions can be extensive and serve as a disincentive for the representative to participate.

Companies have tried to get representatives to disclose lead information and sales activity but this does not normally occur—either due to a desire for confidentiality, a lack of incentive, or the inability to easily transfer the information back to the company. The inability to track, measure, and collaborate easily is due to a large extent to the fact that representatives in many representative selling networks do not share a common platform for information gathering, thus limiting information sharing with the company.

Finally, even if lead information was readily transferred between company and representative, it would necessarily be limited to historical information and would not include updates on pre-sale activity or allow for a transfer of marketing or other collaborative information.

Most software products that exist today in this area are designed around a simple sales model where a company representative is selling directly to a lead. These products are sometimes generically classified as based on CRM (Customer Relationship Management) models. Some of these software products are web based, while others are installed locally on client systems such as a local area network or personal computer. However, these products do not address specific needs associated with the more complex selling model that uses independent representatives or a mixed selling model.

Existing CRM programs typically do not include all entities (company, representative, leads, customers, etc) in the selling model, especially when independent representatives are used. This limits the company's ability to “see through” the representative to the leads.

Existing CRM programs do not allow for collaborative information sharing or lead collaboration within the selling network. They do not provide for incentives tied to specific tasks or actions.

Existing CRM products can be extremely complex and data maintenance intensive, causing low user compliance and low utility. They require extensive training to understand and use.

Existing CRM products do not normally have base data but rather rely on the user to enter information. This limits their ability to be used for prospect searches, to leverage market knowledge, or to generate market coverage statistics.

Another shortcoming of traditional CRM systems is the need to load resident software on the users' systems, making it difficult to upgrade and enhance the programming.

Existing CRM packages do not address the industry problem associated with differing software products and protocols used by the various participants in a representative (or mixed) selling network, thus limiting the ability to easily exchange key information (selling activity, competitive, testimonials, etc.) between entities of the network.

Attempts have been made to overcome the data linkage obstacle between a company and its leads by encouraging the representatives to standardize on one CRM software protocol. However, this has not been accepted, especially by the independent representatives who use different methods to track lead information. Because independent representatives often represent other companies, consensus on a standard package is unlikely.

Moreover, the number of relationships a representative may have with other companies with competing interests will often result in different types of information being maintained (most of which is of no interest to a particular company, or is proprietary representative information), which means that basic information about leads kept by the representative are not easily available. The result is that lead information kept by a representative often is not easily integrated into a representative selling model that utilizes several different representatives and participants.

Finally, the information captured in commercially available CRM packages is more comprehensive than most companies want or need. Most companies need basic and directional information on their representatives' activities. Also, the more detail the company demands from a representative, the less likely the representative is to keep the information updated.

It should be noted that CRM packages have the same limitations described above when they use a mixed model selling structure, where a combination of independent and company representatives are employed to cover a served or prospective market.

Indeed, many companies that have attempted to adapt a CRM model for use in-a representative selling network have failed. Some existing CRM programs are provided by Siebel, Goldmine, Act, and Salesforce.com. Many companies also use ad hoc systems to track leads including paper and electronic reports.

What is needed is a comprehensive and searchable model that enables leads to be easily linked to a company through a representative. The model should clearly assign each lead to a member of the selling network and be updated regularly. In order to drive compliance to the update process, the model should provide a closed loop process that prompts the user to update (if required) and measures compliance to the process. The data should be formatted so that it can be organized into usable reports and “scorecards” and should be able to incorporate mixed model selling structures and other complex selling models. The model also should allow for the exchange of information to improve collaboration and the likelihood of sales wins.

### SUMMARY

One aspect of the invention addresses the above needs by providing a database of core lead information (normally maintained by a company or a service provider) that is enhanced and updated by the user—normally a representative or other member of a selling network (e.g., a salesperson) for purposes of providing a company and users with information about leads, sales, and market activity. In a networked system, a company or service provider maintains a host/client server and members of the selling network communicate with the host over the network.

The system preferably is set up using company and representative organizational hierarchies that establish a linkage between the company and the representative. The representative logs onto the system to “tag” the lead, thereby creating the remaining linkage between the company, the representative and the lead. Thus, the invention provides a linkage between all entities in the selling network.

System users enhance commodity lead information by providing potential, competitive information, prospects, selling stage and any desired “registration” information deemed valuable, to the core record.

The system user can be automatically prompted to update the system. The user updates the system on a regular basis that includes but is not limited to information such as sales activity, selling stage, and contact information. The system keeps the company informed on market activity, lead status, and virtually any other information desired.

The system can be used to measure market coverage and derive penetration statistics. By loading lead data into the system, a given representative can be measured against the number of prospects in their defined territory and/or market and their actual coverage. This allows a company to better align selling resources around their served and prospective markets.

The system can be used to share information (including market “scripts” and testimonials) across the selling network. This overcomes challenges that companies and representatives encounter when they Want to drive information throughout the selling network. This allows the company and representative to tailor a “script” to specific markets, customers or leads. Links may be created that connect the user to key marketing information that may comprise specific market scripts, PDF files, and customer testimonials.

The system can be used to administer programs where a company uses representatives to serve a common customer or representative with multiple locations, through clear assignment of locations to members of the selling network, and to ensure a consistent customer and market approach.

The system can be used to collaborate across the sales network in the case of “project” type sales. When a project involves a sequence of events and/or using multiple representatives (both company and/or independent representatives), the system can track and measure each phase and ensure a “handoff” to the appropriate representative at each phase. This allows the company to meet the needs of the lead seamlessly across a diverse selling network.

The system also benefits company-representative relationships, since it streamlines promotional offers and other incentive programs. The company can simplify incentive administration and focus promotions on select leads, customers or markets. The system streamlines drawn out and documentation intensive approval processes as well.

The system can be used to share sales lead information and to drive a follow through process by the representatives. Leads can be flagged in the system and automatically assigned to the representative for follow up or action. This not only streamlines the process but ensures that assignments are given and actions measured.

The system can also provide representatives with a resource for pursuing clients by searching through the database of potential leads provided with the system. The system also can provide a measure of protection for representative lead information.

The system maintains a history of lead information. This is especially useful when transitioning to a new representative or during territory realignment. Many companies do not document this information, leaving them vulnerable to the risk of losing or ignoring leads during times of transition.

The system is accessible remotely and at any time, making the system particularly beneficial to companies using a global network of representation in differing time zones or to users that do not own computer hardware.

The system can also incorporate mixed selling models that use combinations of independent and company representatives.

In one embodiment, the invention comprises a system for monitoring business activity for a company using a representative selling network, including a database of potential and existing leads offered by a host company at a server; a plurality of client servers communicating representative-lead information to the server; a representative access means for accessing the database and tagging leads, including inputting a user's lead information into the database; an activity posting means for posting activity in leads; and a means for periodic reporting of lead information including a summary of sales activity between a representative and a lead.

In one exemplary embodiment, the invention comprises a system for linking leads among representatives and a company, and the system includes components for data preparation, user registration, searching and tagging, post and view activity, and reporting. Each of these components of the system may reside on one or more computers which may be connected locally or distributed over a network-based system.

Data Preparation

The system preferably is set up with lead information. Data comes from any number of sources including the company, the representatives, and/or commercially available data services.

The data is loaded into the system and distributed to the appropriate representatives. The data can be distributed according to various criteria, such as geography, market, lead type, etc. In a simplified implementation, the data can be assigned directly to a representative to track, without the use of more sophisticated programming for data allocation.

The system can be enhanced with organized marketing data—supplied by various sources including the company, representatives or others—and organized by industry type, lead name, etc.

Registration

Users register on a network (e.g., Internet) site, provide contact information, and capture relationships of the user in the selling hierarchy. An example of a representative selling model hierarchy is depicted in FIG. 3. Reporting structures are programmed into the system in advance of registration, allowing for clear “linkage” from the system user to the selling hierarchy.

Searching and Tagging

The system allows a “tagger”—typically a representative—to query on multiple variables to look for potential or existing leads. The tagger may then “tag” a lead by clicking on that lead and claiming that lead as theirs.

Lead tagging allows system user to claim a lead, which the system then associates with the system user. Through relationship logic, the system also associates the user into the selling hierarchy (see FIG. 3).

During the “tagging” process, the system user may enhance the base data with company-specific information such as contact names, competition, potential, types of products used, re presentative relationships, and virtually any other information that may be usable to qualify the lead.

In exchange for tagging a lead, the sponsoring company may provide a number of incentives, including but not limited to lead protection, special promotions, functional discounts, and other representative incentive programs. Each tagged lead becomes the responsibility of the tagger—typically a representative—to track and update.

The system also may provide: (a) collaboration on multi-location leads and customers; (b) collaboration on project type leads; (c) sales lead management and prioritization; and/or (d) promotional support and streamlining.

The system may be configured so that only qualified data appear in the search process. Programming may be employed to align appropriate data from databases with discrete qualifications for each user.

Email summaries may be sent to users after tagging.

Post & View Activity

After tagging the lead, the representative is obliged to post regular activity reports. The following features may be employed in connection with posting activity reports: (a) a reminder system to alert the user of open activity requirements; (b) prompts by email, phone or any other electronic means; (c) simple “point & click” activity updating and help requesting; (d) updates on selling stage, quotations and even revenue; (e) search capability on activity records; and/or (f) simple “point & click” links to organized marketing data.

Activities may be categorized for easy selection and retrieval. For example, a user may simply click on an activity type, thereby compiling and retrieving information relating to that activity. Activity posting overcomes industry challenges through the use of predefined fields versus traditional “free form” data entry formats. The use of discrete definitions allows for simplified information retrieval and organization and ultimately simple, easy to use reporting.

Report formats allow for easy decision making and more objective information tools. Compliance to posting activity is enhanced through the automatic notification system employed by the system. This includes email alerts upon registration and tagging as well as reminders of inactivity. This closed loop system drives reinforcement of system compliance.

Reporting

The lead tagging and information posting process facilitates the easy capture and organization of reports, which enhances the usability of the system. Because the system incorporates a sales network hierarchy, user registration, lead data, lead tagging, and updates in a database, virtually any type of report can be generated using the various dimensions and variables recorded in the system.

Reports may be fashioned to track market activity of the representatives. These reports may include information such as market coverage statistics, lead follow-through, hit rates of programs, representative performance, and representative commitment. Representatives can be provided incentives through use of reporting statistics.

Reports are summarized according to hierarchical structure, allowing for generation of reports relevant to the user's level in the hierarchy. Reports can be generated that: (a) measure selling performance; (b) measure market coverage; (c) identify market strengths and weaknesses; (d) capture key market opportunities; and (e) facilitate effective market & product penetration initiatives.

In one aspect, the invention comprises a system for tracking lead information related to a representative selling network, comprising: (a) means for acquiring and storing lead data relating to leads of a representative selling network; (b) means for registration of a member of the representative selling network; (c) means for enabling the member to search, tag, or be assigned the lead data; (d) means for enabling the member to post activity data relating to the leads; and (e) means for preparing reports based on the lead data and the activity data.

In various embodiments: (1) the lead data is acquired from one or more of: company sources, representative sources, and third-party sources; (2) the registration is performed according to the member's position in a hierarchy governing the representative selling network; (3) the system further comprises a means for rewarding the member for posting the activity data; (4) the means for tagging comprises means for associating the member with tagged lead data; (5) the searching comprises querying on multiple variables to look for potential or existing leads; (6) the rewarding comprises one or more of: lead protection, a special promotion, and a functional discount; (7) the system fturther comprises one or more of: means for enabling collaboration among the member and one or more other members regarding multi-location leads; means for enabling collaboration among the member and one or more other members regarding project type leads; means for enabling sales lead management and prioritization; and means for enabling promotional support and streamlining; (8) the tagging comprises enhancing the lead data with one or more of: contact names, competition, potential, types of products used, and representative relationships; (9) the system further comprises means for updating the lead data; (10) the system further comprises means for reminding the member to post the activity data; (11) the system further comprises means for enabling collaboration between members of a mixed selling network hierarchy; (12) the system further comprises means for enabling collaboration between independent and company representatives; (13) the means for enabling collaboration is operable to enable collaboration based on local market conditions and approaches; (14) the reports comprise information relating to one or more of: market and customer coverage statistics, lead follow-through, hit rates of programs, representative performance, competitive information, and representative commitment; (15) the reports are based at least partially on the member's position in a hierarchy governing the representative selling network; (16) the means for enabling the member to post activity data comprises means for presenting pre-defined data entry fields for posting activity data; (17) a first portion of lead data comprises one or more hyperlinks to a second portion of lead data; (18) the system further comprises means for customizing commodity data to users or clients based on usage of the commodity data; and (19) the means for reminding is part of a means for providing a closed loop process.

### BRIEF DESCRIPTION OF THE DRAWINGS

FIG. 1 illustrates an example of representative multiplicative benefit.

FIG. 2 depicts an example of territory setting capability.

FIG. 3 depicts an exemplary selling hierarchy.

FIG. 4 illustrates lead searching.

FIG. 5 depicts an exemplary search results display.

FIG. 6 depicts an exemplary search record detail.

FIG. 7 depicts an exemplary menu for tagging a lead.

FIG. 8 depicts an exemplary registration acknowledgement.

FIG. 9 is a flow chart illustrating an exemplary process for tagging a lead.

FIG. 10 illustrates multi-location collaboration.

FIG. 11 illustrates project collaboration.

FIG. 12 is a flow chart illustrating an exemplary process for project collaboration.

FIG. 13 illustrates sales lead administration.

FIG. 14 illustrates promotional administration.

FIG. 15 depicts an exemplary focused market information link.

FIG. 16 depicts an exemplary update reminder message.

FIG. 17 depicts an exemplary template for activity posting.

FIG. 18 depicts an exemplary system user help request.

FIG. 19 depicts an exemplary system user help request message.

FIG. 20 depicts an exemplary activity record search result.

FIG. 21 is a flow chart of an exemplary process for posting an activity report for a lead.

FIG. 22 illustrates preferred database creation.

FIGS. 23, 24, and 24a depict examples of sales activity reports.

FIG. 25 depicts a sample report regarding market coverage statistics.

FIG. 26 depicts a sample report regarding selling stage statistics.

FIG. 27 depicts an exemplary hierarchy and related reporting capability.

### DETAILED DESCRIPTION OF PREFERRED EMBODIMENTS

The following provides a detailed description of currently preferred embodiments. However, those skilled in the art will recognize that the disclosed embodiments may be modified in various ways without departing from the scope or spirit of the present invention. The appended claims are intended to describe the actual invention, and should not be construed as to cover only the embodiments described herein.

A preferred system embodiment can capture data that is otherwise difficult to gather and organize. It brings objectivity, measurement, and collaboration to the representative selling process.

Through system use, commodity and commercially available data is enhanced with client specific information. System users enhance base records through system use making the information more specific to the client and the system users.

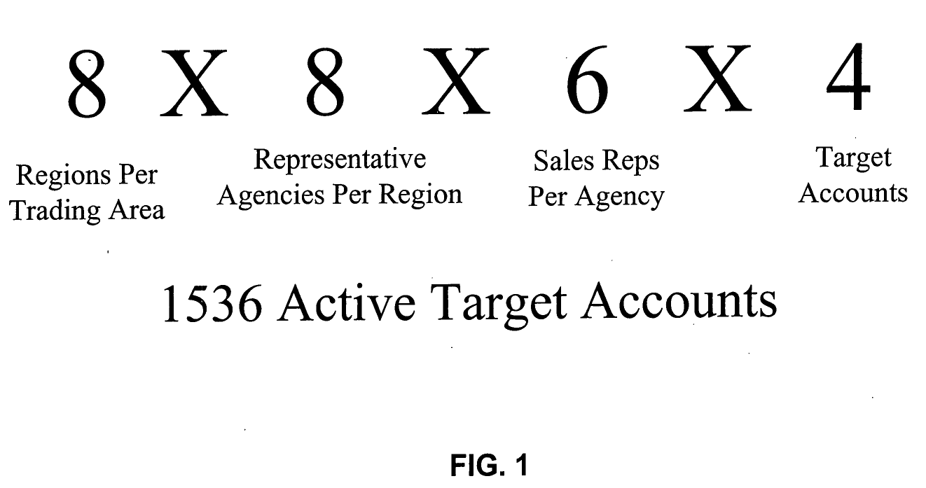

The system drives higher levels of accountability and better taps the “multiplicative” benefit of the assignment of leads to representatives (see FIG. 1). That is, if a company uses representative agencies, it has the potential of tapping a significant amount of activity due to the number of participants in the selling chain. The preferred system embodiment captures the power of this effect. Regular tracking and selling activity at the lead level will drive the representative to close more sales on behalf of the company and representative.

The system drives compliance through a closed loop reminder process, preferably integrated with an easy-to-use point and click format. This format eliminates anecdotal reporting by the representative and generally streamlines information exchange.

A preferred system embodiment includes system set-up, registration, searching and tagging, post and view activity, and reporting components.

System Set-Up

The system preferably is set up with records (leads) generated by the company. These records may be commodity type records available from commercial data services such and Dun & Bradstreet. The data record may include dimensions such as lead name, address information (street, city, state, county, etc), contacts, industry code, number of employees, etc. This record typically would not, but might, include company specific information such as potential, products and competition used, etc. Data also may come from notification services such as FW Dodge, which markets project and project status notifications for building contracts and related information.

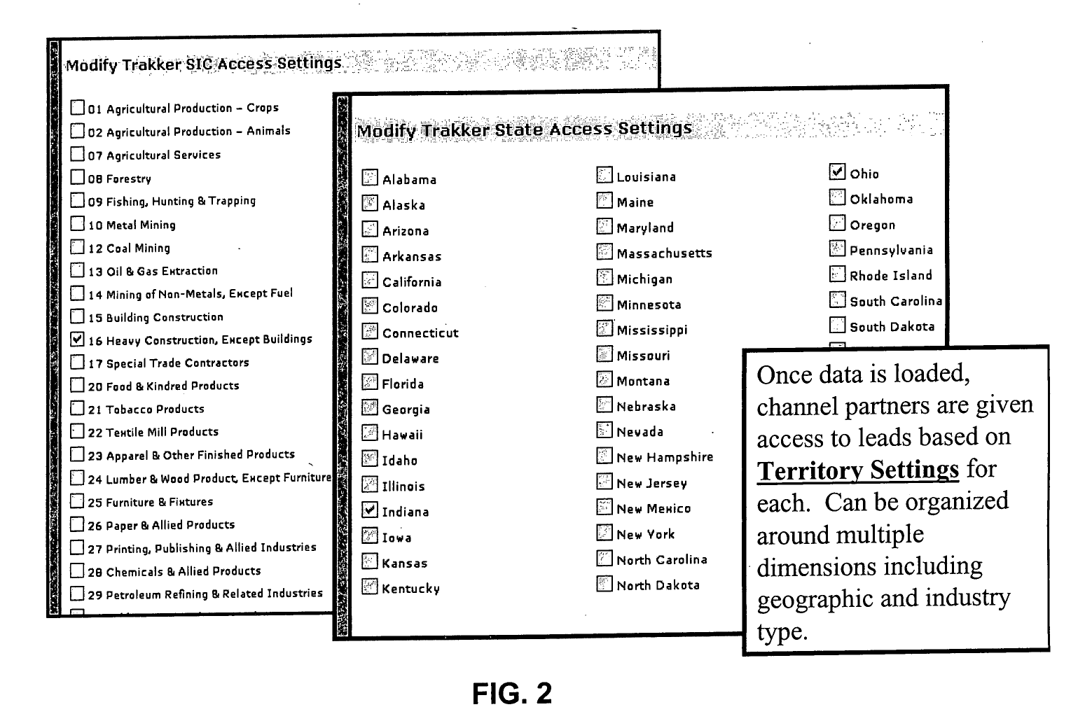

Representatives can be assigned a given geographic territory or market, or specific leads through the system. The system preferably can align lead data in the system with each representative, so that each representative is given access only to the leads they are responsible for. This preferably is controlled through system “territory setting” fields (see FIG. 2).

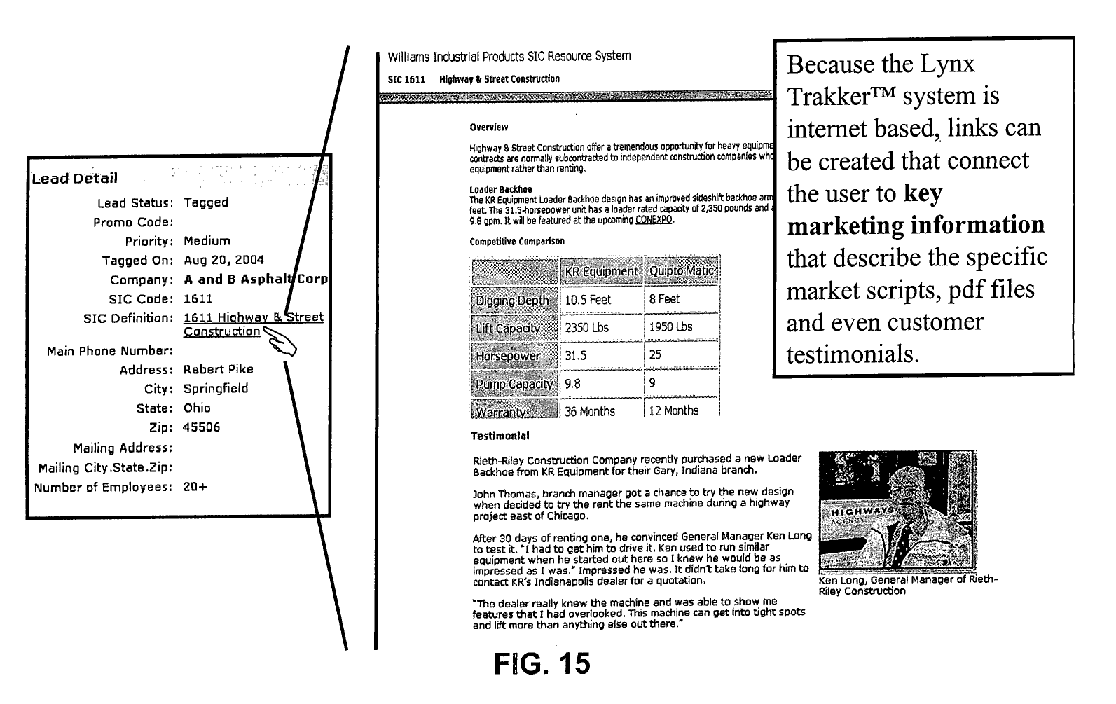

The system also may be enhanced with organized marketing data by industry type, lead name, etc. All leads for a given market dimension—say industry code—may be populated with relevant marketing information, including application, product, and competitive information, enhancing understanding of the lead and the potential for selling success. Marketing data ,which often loses its usefulness because of how it is communicated, is systematically linked to specific leads and available upon demand. Examples of this marketing information include website links, pdf files, html files, form numbers of brochures, product specifications, etc. (see FIG. 15).

Registration

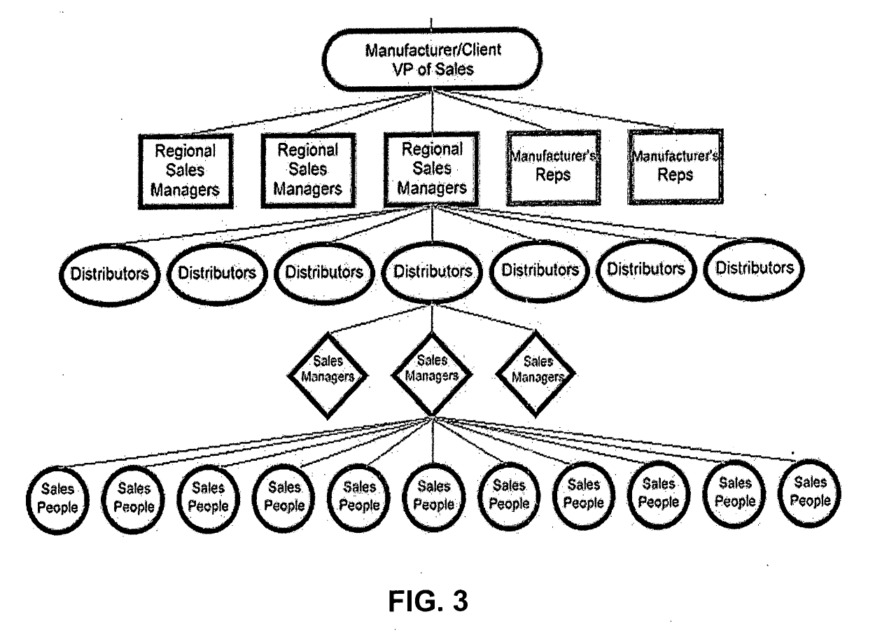

Users of the system register on the site and provide contact information and the relationship of the user in the selling hierarchy (see FIG. 3). This information enables, information access, enhanced reports and reporting relationships.

Searching and Tagging

A preferred system embodiment uses global lead data from a variety of potential industry sources such as D&B, Harris, and/or others. Typically, the company provides this information. Preferred data fields include (but are not limited to): name, address, contact information, and market. The scope of the data and the number of records can be varied depending on the company's needs. Records can be added to accommodate changes in lead information. Markets and leads can easily be prioritized through data flagging, drawing high potential leads to the top of the list.

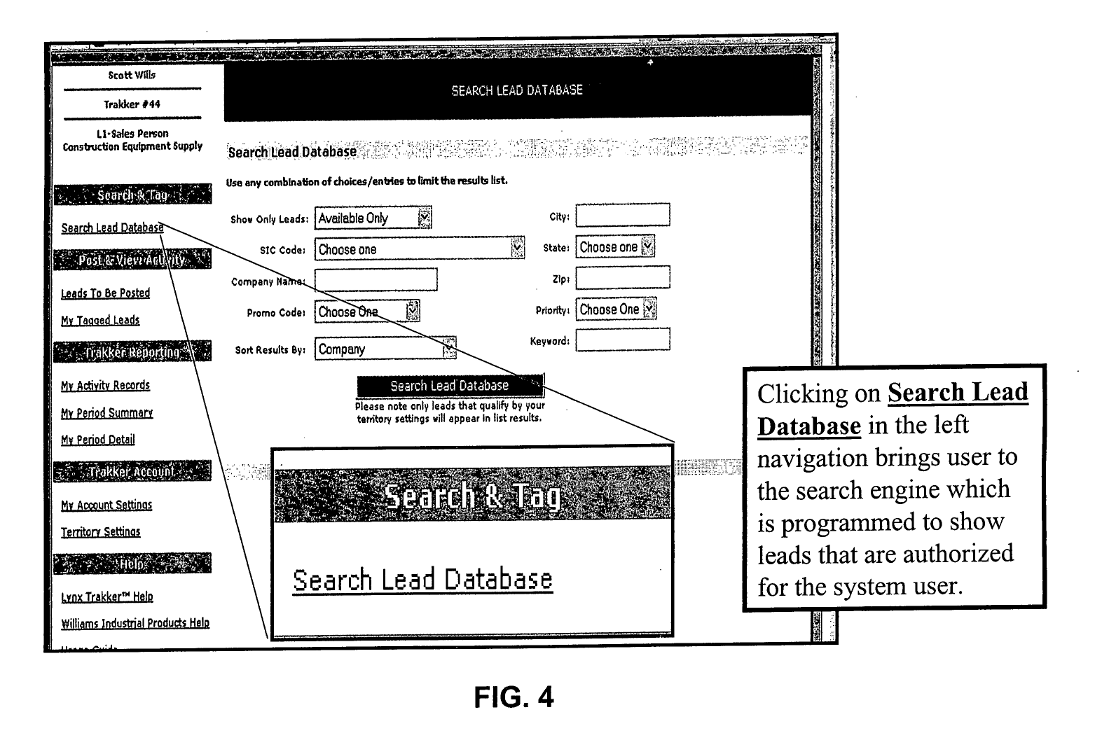

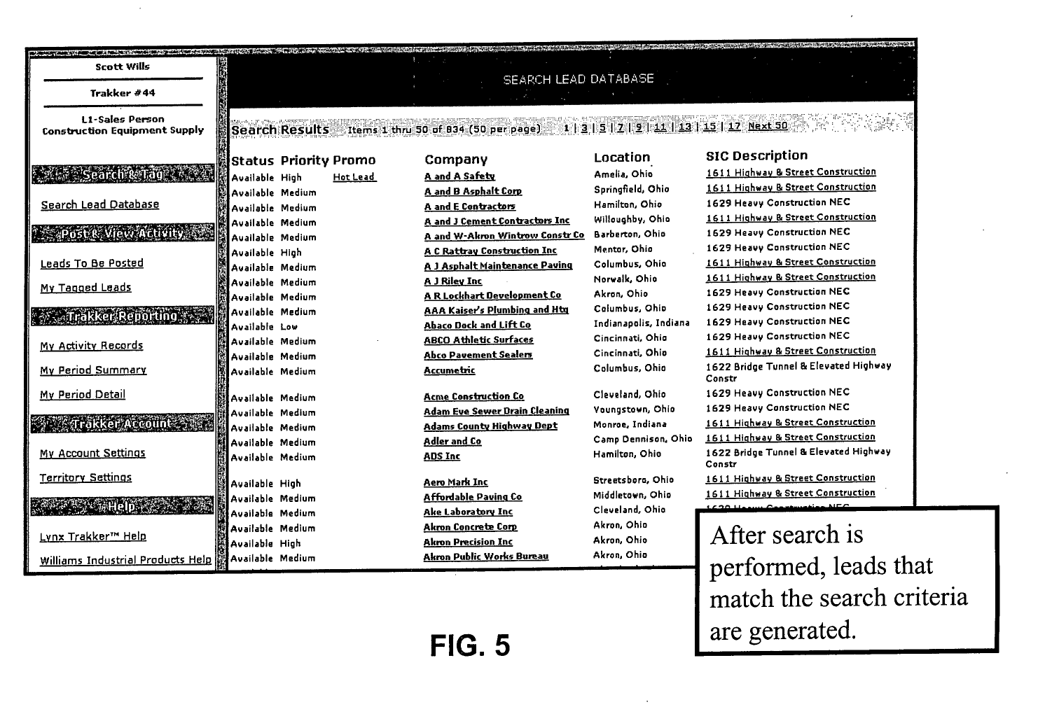

A preferred system embodiment allows a “tagger”—typically a representative sales person—to query (see FIGS. 4 & 5) on multiple variables to look for potential or existing leads. FIG. 4 depicts a menu for searching for potential or existing leads. FIG. 5 depicts a screen that displays results from a query showing potential leads maintained in the database. In this example, lead names are listed with their SIC code for the Ohio region. Those skilled in the art will recognize that account data may be organized or obtained using a variety of industry classification systems (such as SIC, NAICS, ISIC, or HS).

The system also may be configured so that leads in the system can be directly assigned to a user rather than requiring a user to use the search functions depicted in FIGS. 4 & 5.

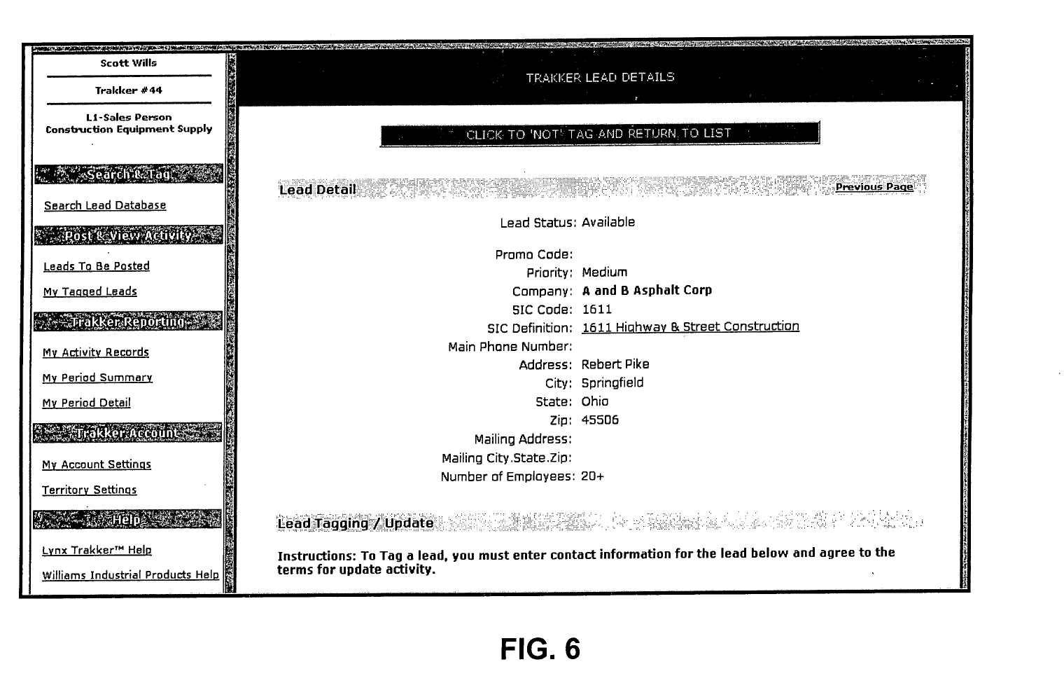

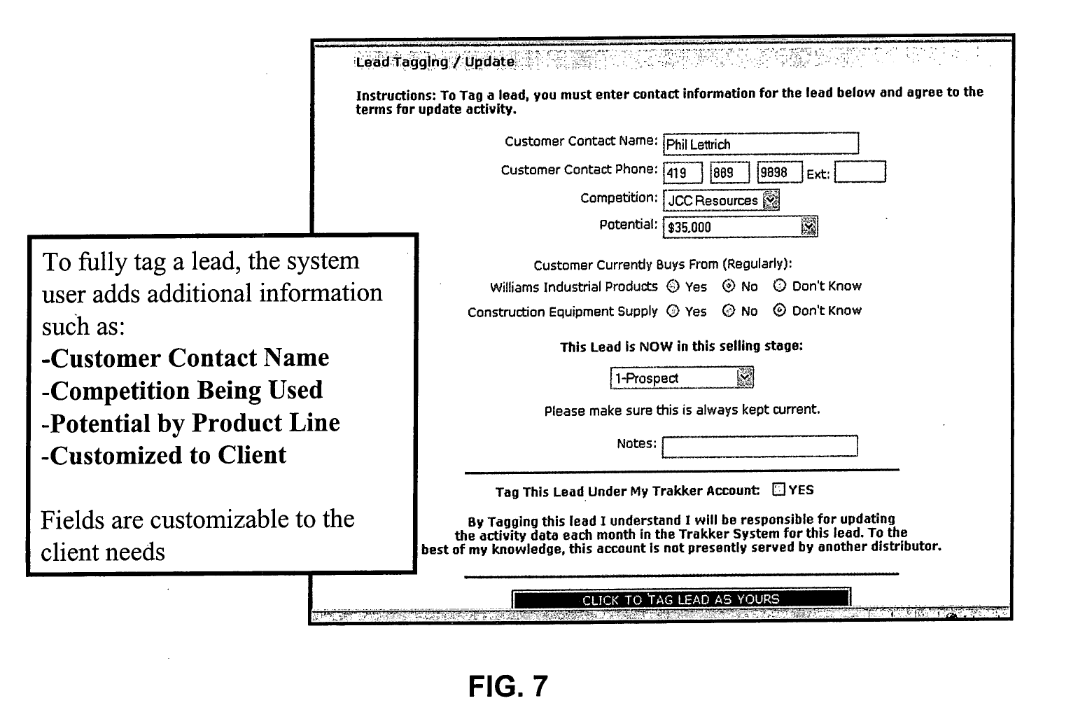

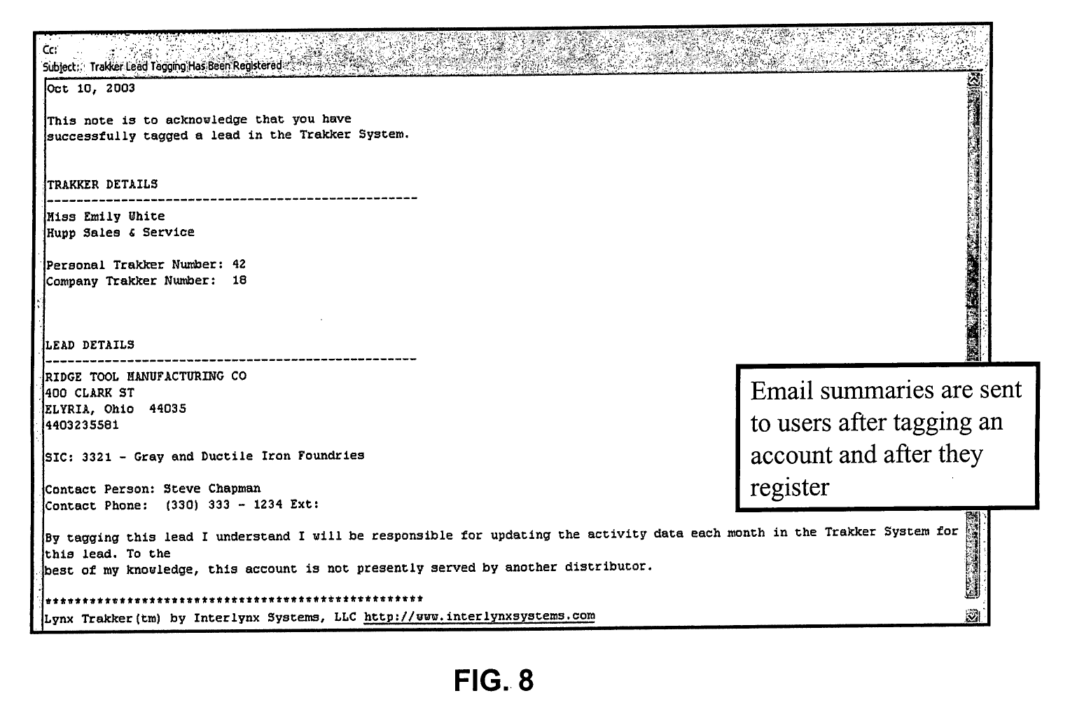

A tagger may “tag” a lead by clicking on leads that come up as part of the search (see FIG. 6) and to “claim” that lead. The system may be configured to ask any number of “registration” questions—these typically would be qualification type questions such as competition, potential, prospects, and/or contact information. The system user preferably must complete this section in order to “tag” the lead. (see FIG. 7). Then the system user receives a lead registration acknowledgement (see FIG. 8).

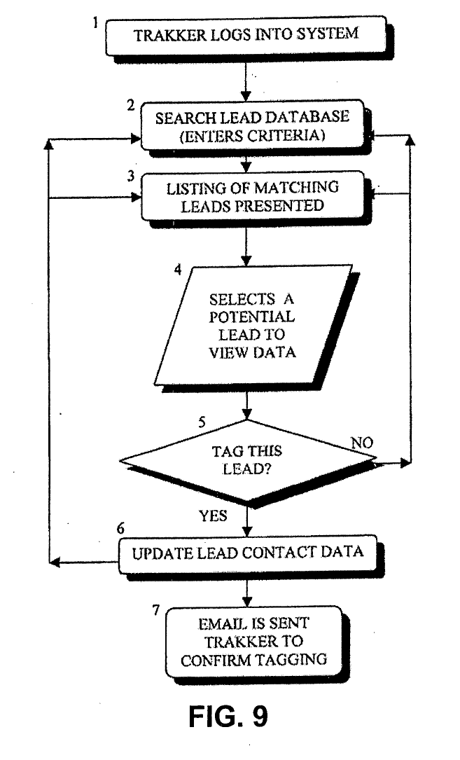

FIG. 9 depicts a preferred flow process for tagging a lead. After logging into the system (1), the system user enters search criteria for potential or existing leads (2). The results from the search are then displayed (3), and information for a potential lead is selected and displayed to the tagger (4). If the lead is tagged (5), the lead contact information and/or qualifying information is entered into the database (6). A confirming e-mail is then sent to the system user to indicate that the lead has been tagged and information entered into the system (7). Confirming e-mails can be copied to others in the selling network as desired. This process links all entities in the selling network.

In exchange for tagging a lead, the sponsoring company may provide a number of incentives, including but not limited to lead protection, functional discounts, special promotions, and other representative incentive programs. Each tagged lead becomes the responsibility of the tagger at the representative agency.

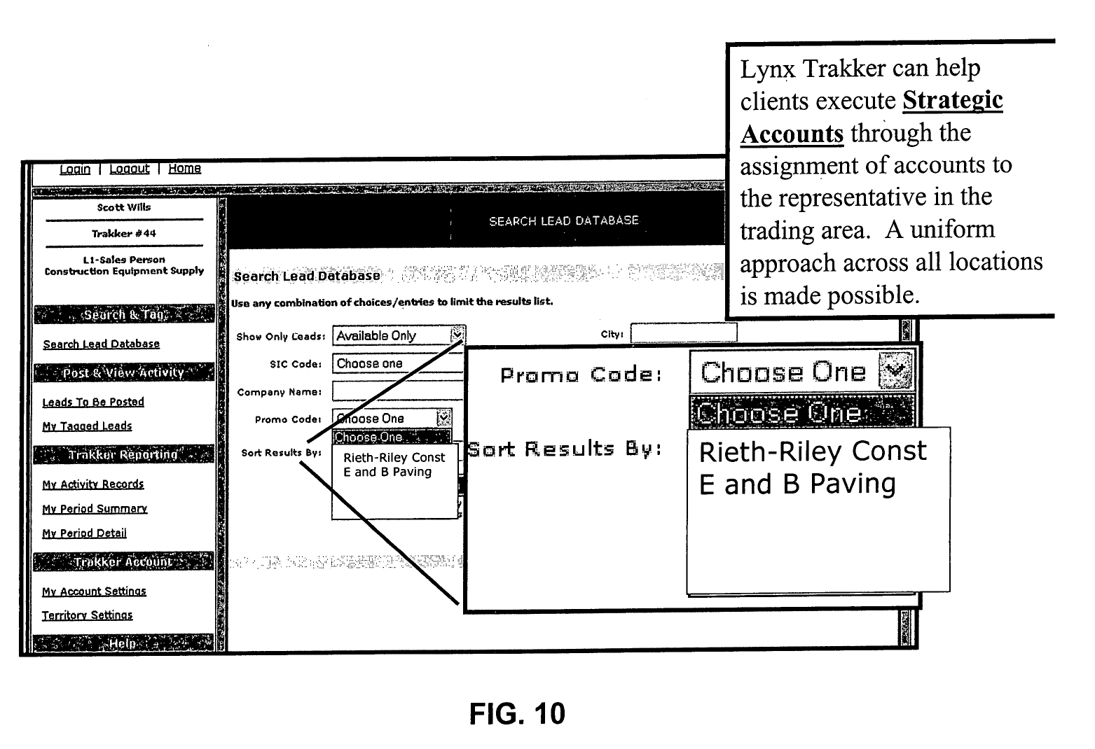

The system can be used to prioritize lead tagging for collaboration on multi-location leads (see FIG. 10). The system can be used to drive collaboration across multi-location leads. The representative is “assigned” specific locations through the system by direct assignment or by searching the database. Through the registration and update process, consistent and regular sales activity at the company's locations can be coordinated. In addition, the visits can be scripted around the specific needs of the lead though hyperlinks.

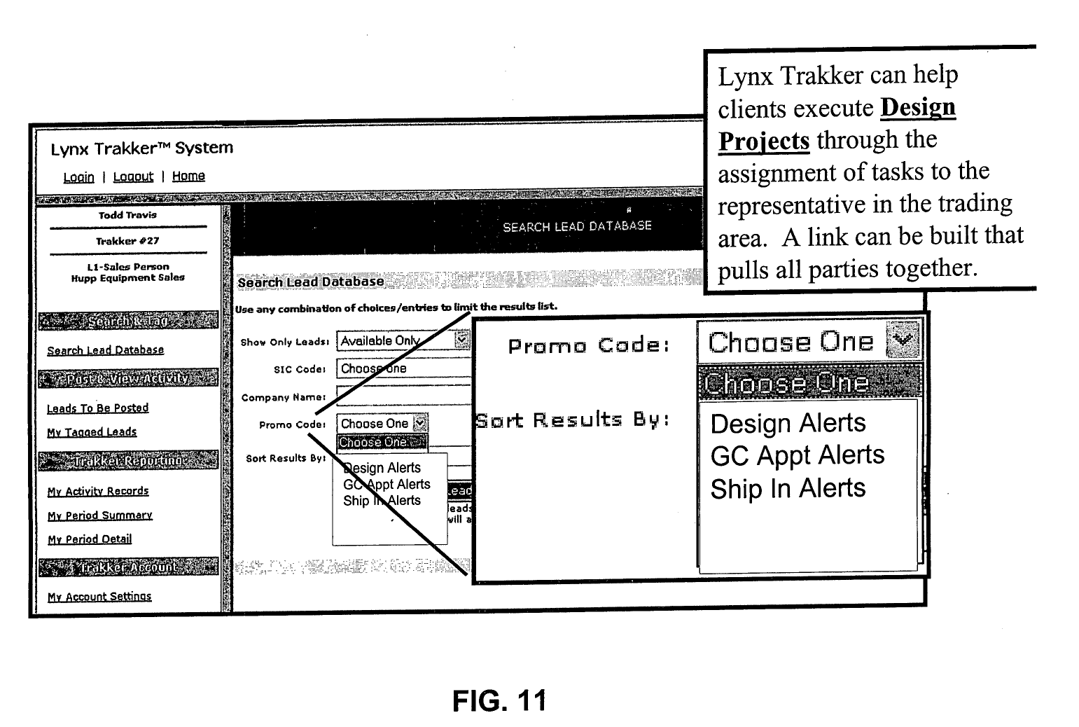

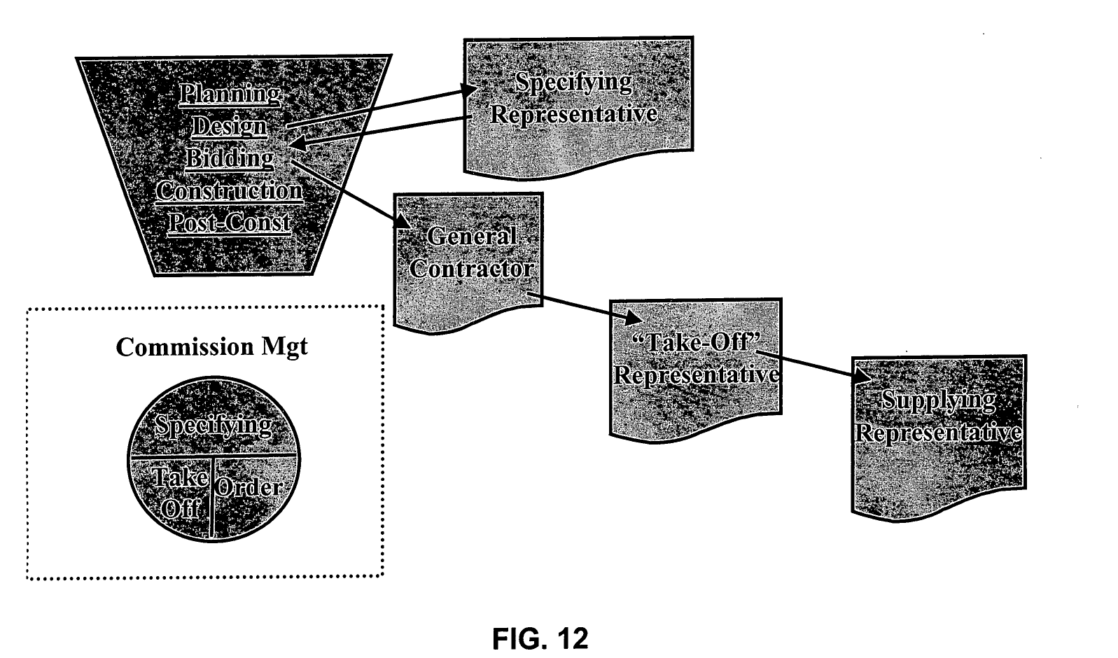

The system also can be used to prioritize lead tagging for collaboration on project type leads (see FIGS. 11 & 12). Project type leads can be managed through the system. Because of the phased approach of project work, there is often a need for different representatives to participate in a project at different times. The system may use information from services such as FW Dodge (which provides information on building, engineering, utility, and general projects), or from those familiar with the project timing, to assign phase-specific tasks to the responsible participant to ensure that the project is managed seamlessly.

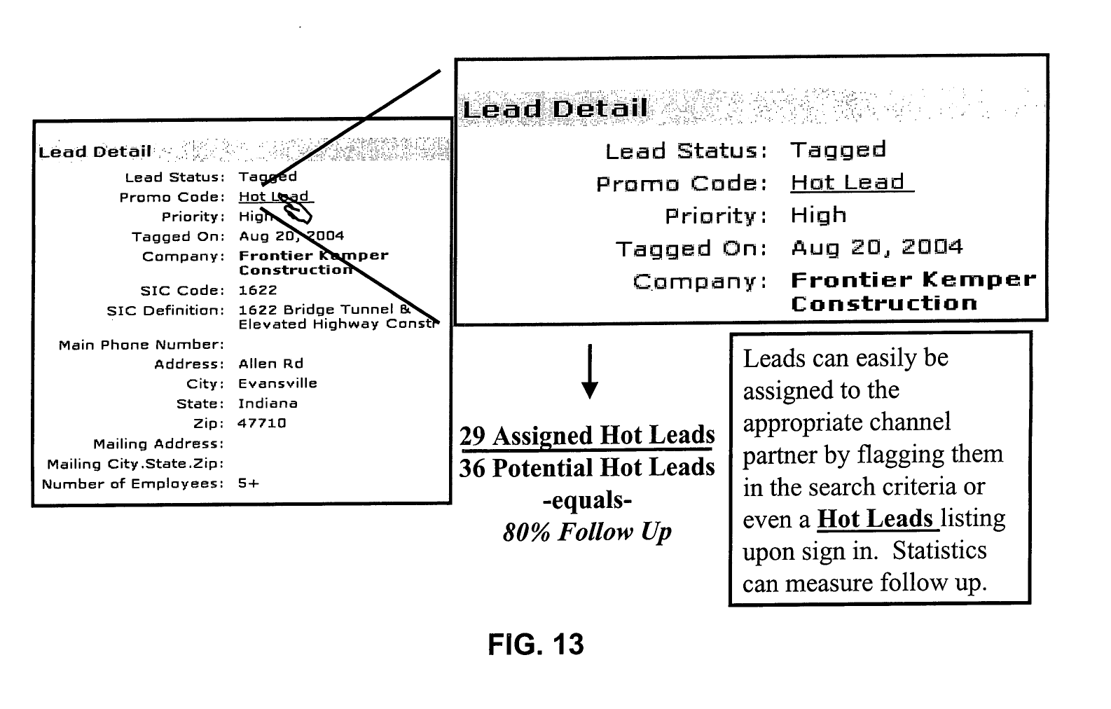

The system also can be used to prioritize lead tagging for sales lead management and administration (see FIG. 13). The system can be used to prioritize sales leads or other data so that the company can not only expedite the process of lead follow up by the representative but also allow for measurement of follow up compliance as well as ROI calculations.

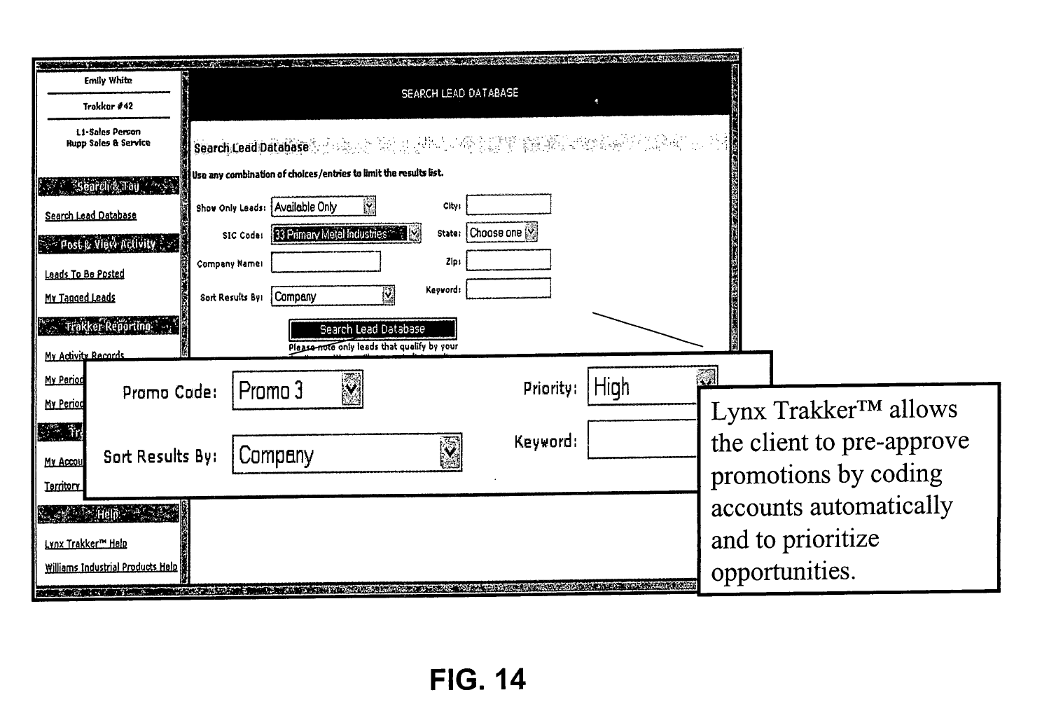

The system also can be used to prioritize lead tagging for promotional support and administration (see FIG. 14). The system can be used to automate the approval process for promotional activity such as special pricing and special deals. The system will allow the “flagging” of specific leads eligible for promotions, and allow for hyperlinks to supporting promotional material. Programs focused on specific customers, markets, or even those using a specific competitor can easily be managed through the system.

Post & View Activity

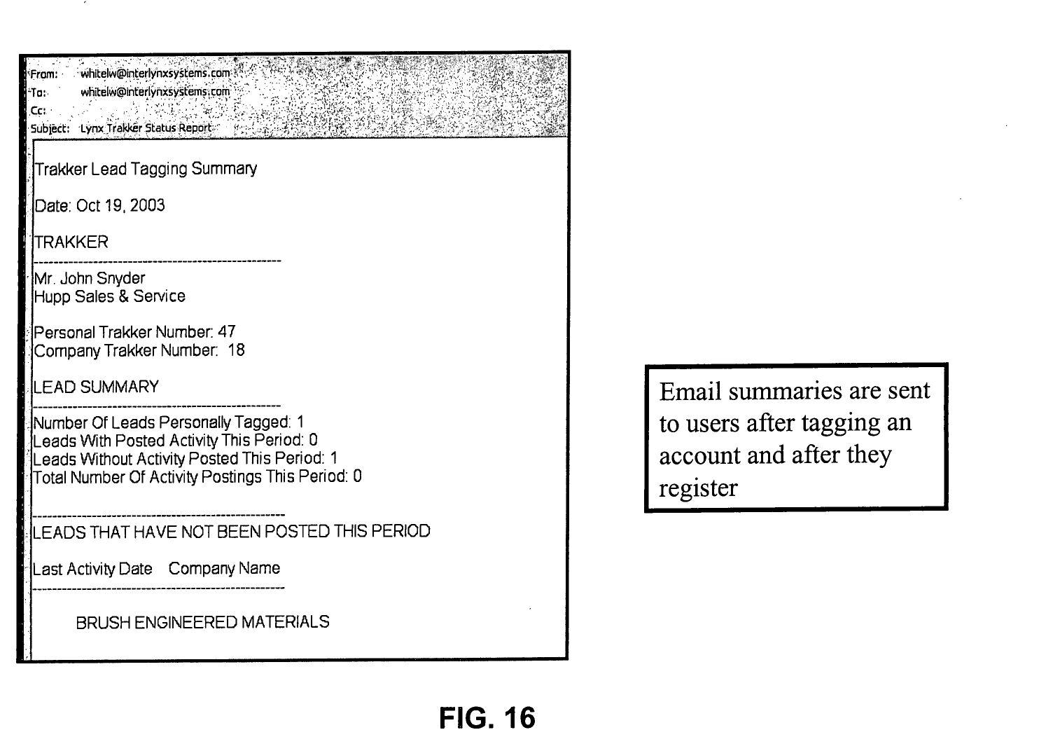

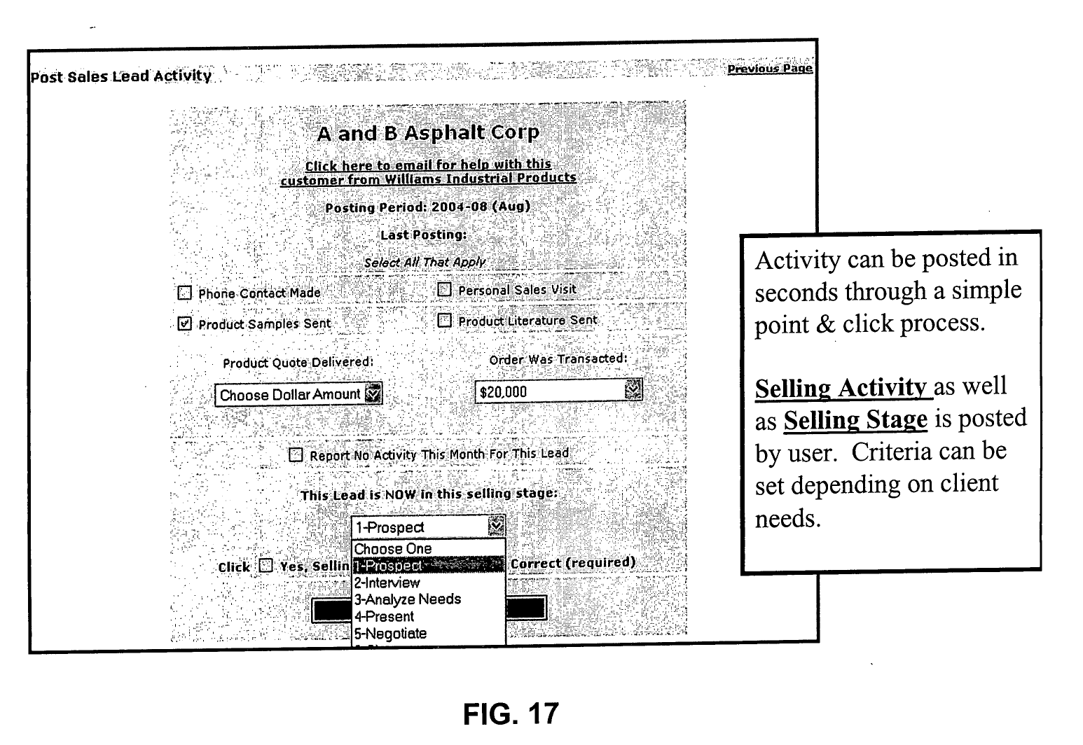

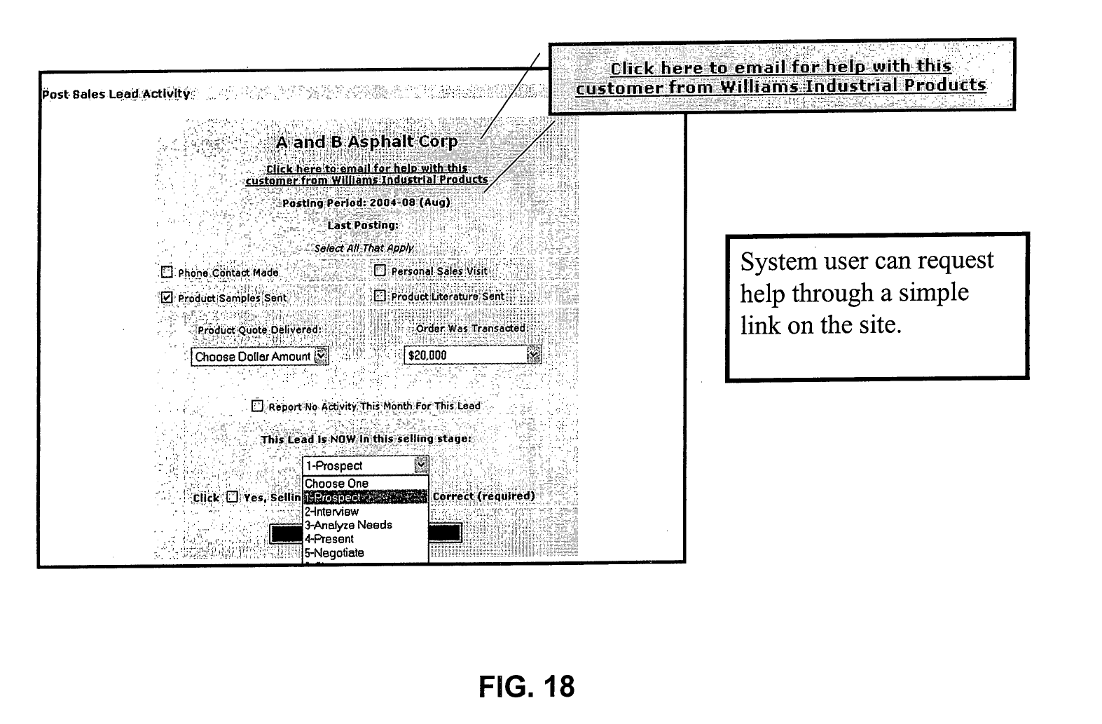

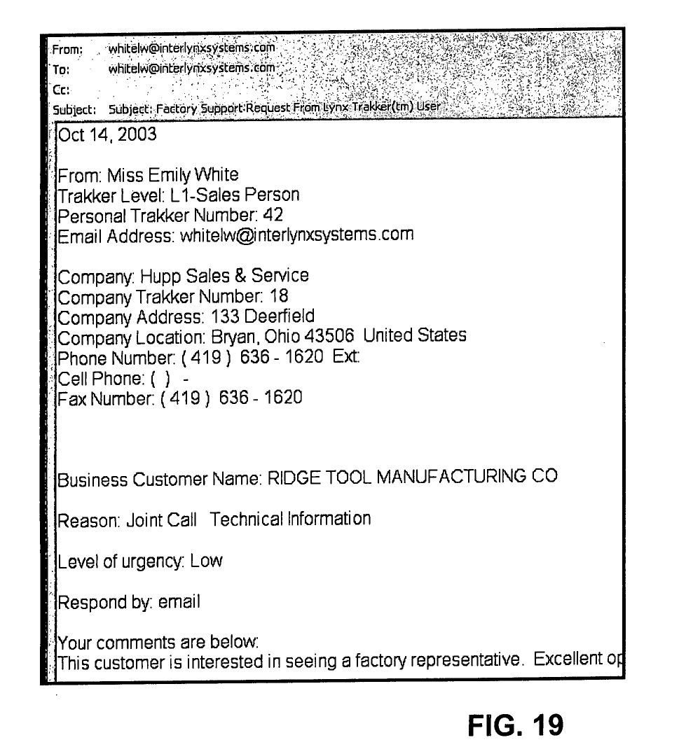

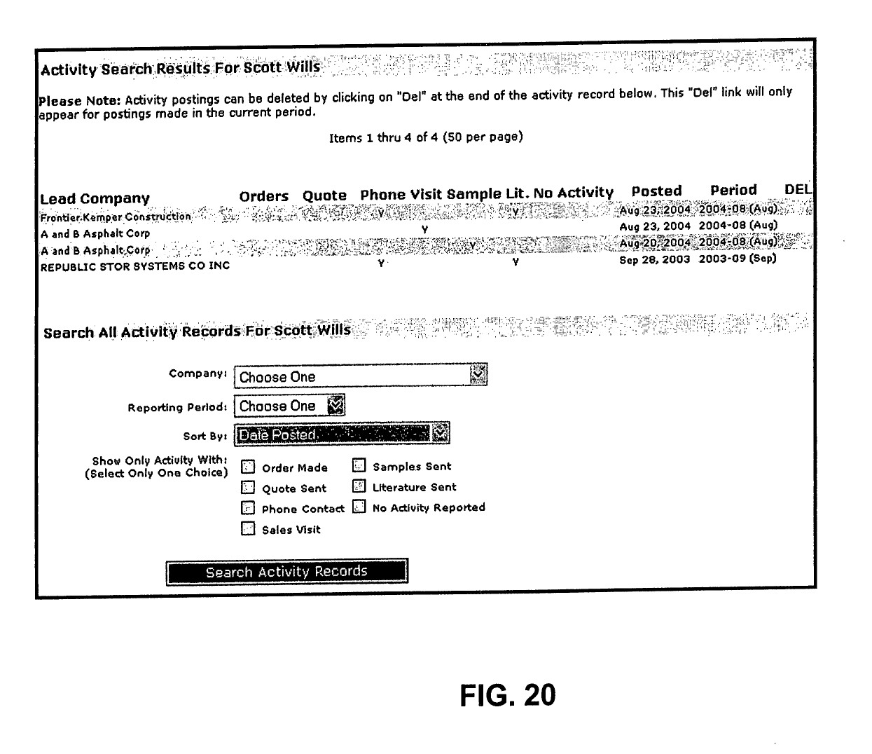

After tagging the lead, the tagger is obliged to post regular activity reports. A preferred system embodiment makes this simple by employing one or more of the following features: (1) reminder system to alert the user of open activity requirements; (2) prompts by email, phone or other electronic means (see FIG. 16); (3) simple “point & click” activity updating (see FIG. 17) and help requesting (see FIGS. 18 & 19); (4) search capability on activity records (see FIG. 20); and (5) simple “point & click” links to organized marketing data (see FIG. 15).

Activities may be categorized for easy selection and retrieval. The system user preferably clicks on an activity type and the information is easily compiled and retrieved (see FIG. 17).

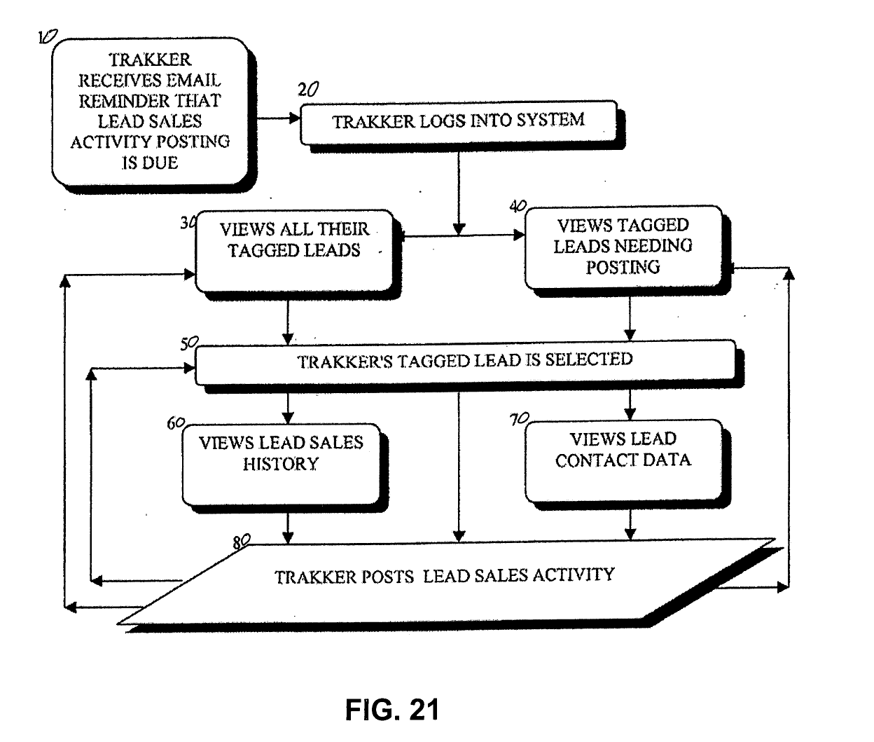

FIG. 21 depicts a preferred flow diagram for activity posting by the user in response to an e-mail notifying the user that lead sales activities are due (10). After logging into the system (20), the user views all tagged leads (30) and identifies those leads that need posting (40). For each tagged lead (50), the sales history (60) and contact data (70) are viewed and the lead's sales activities are posted.

The system preferably can be configured so that system users and other stakeholders (cc to supervisor, etc.) will be alerted to non compliance on any outstanding activity. Statistics on compliance can be used to drive better compliance levels.

Reporting

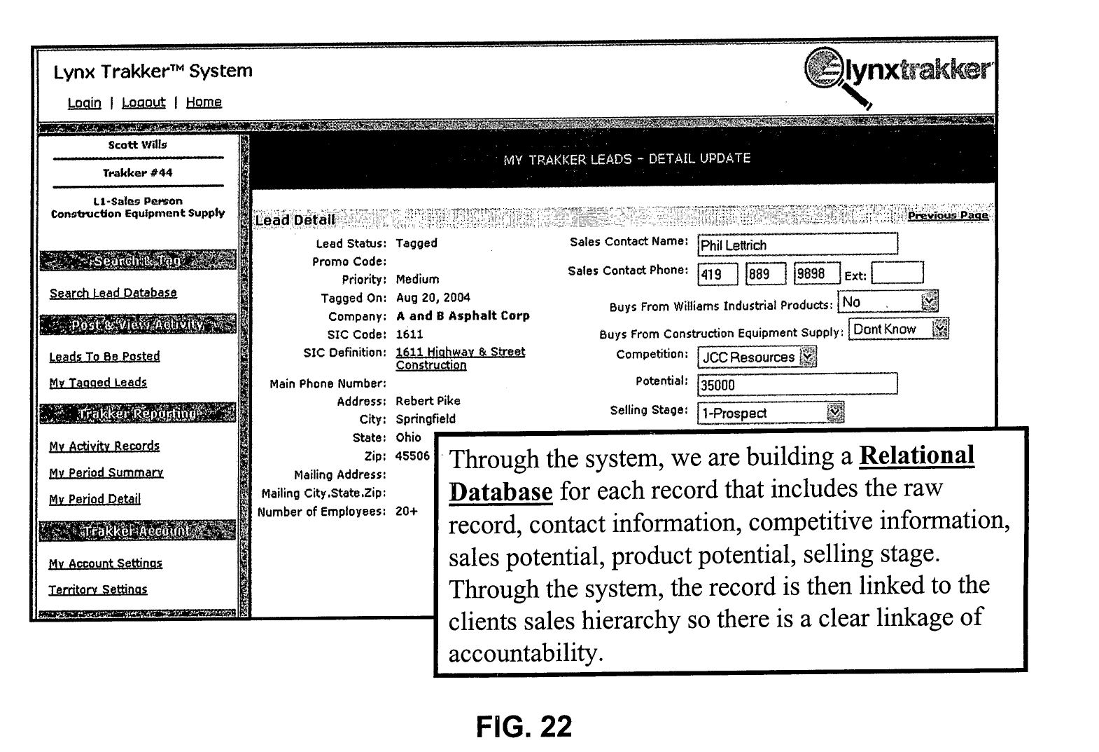

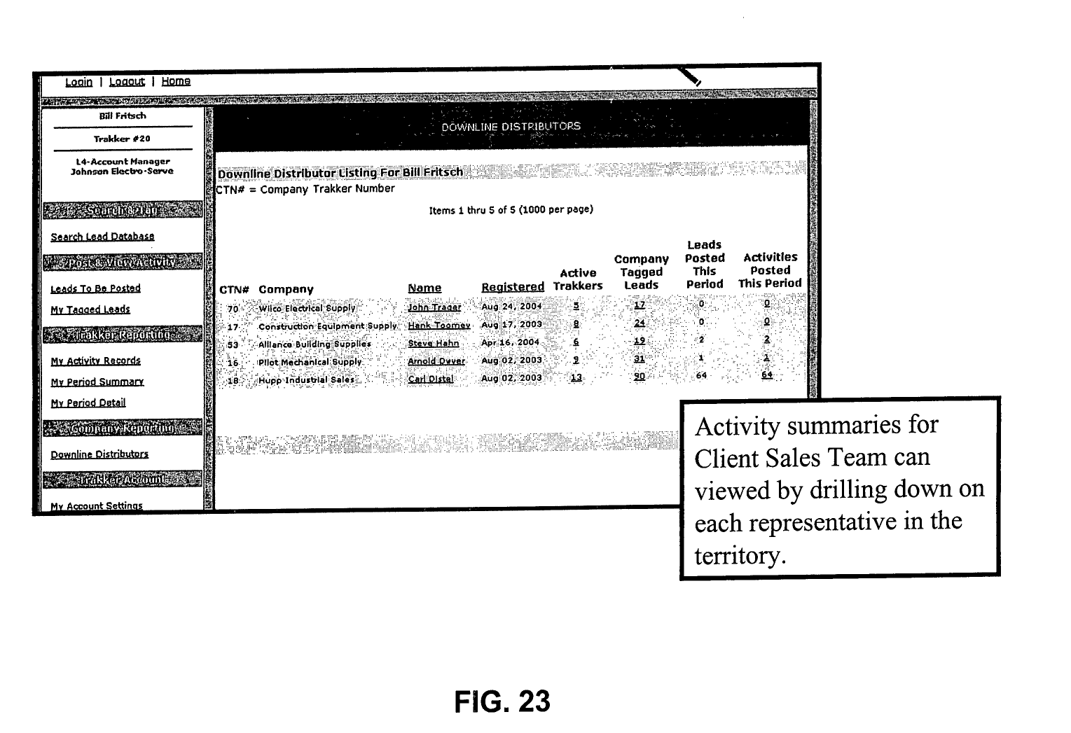

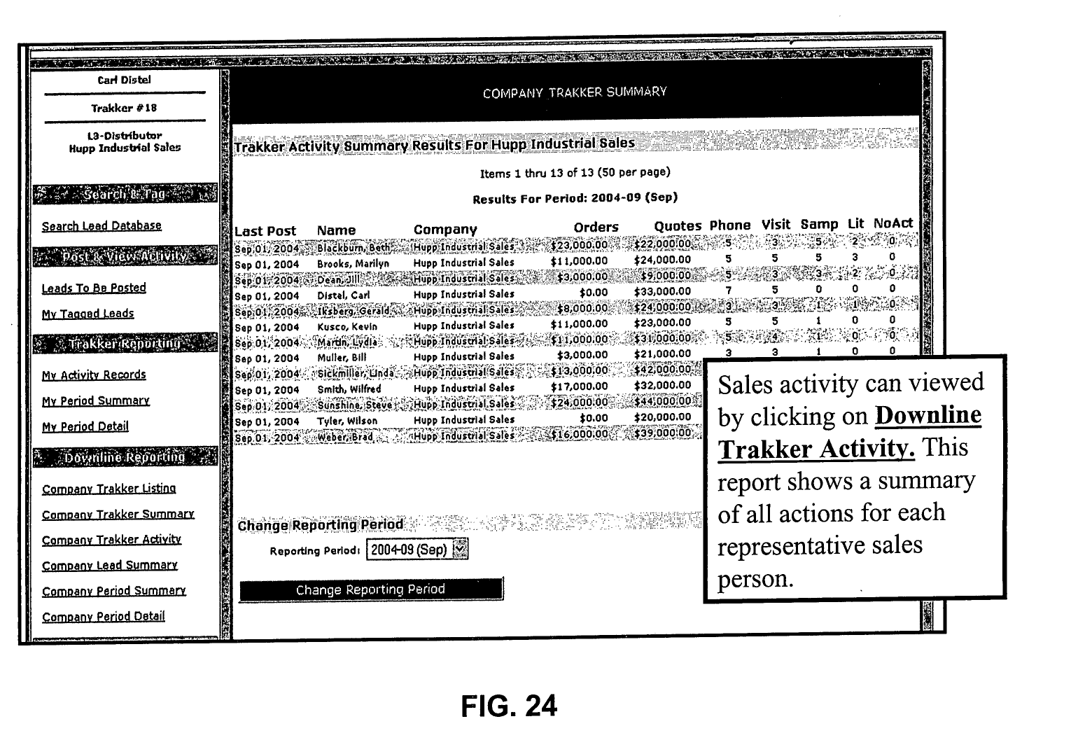

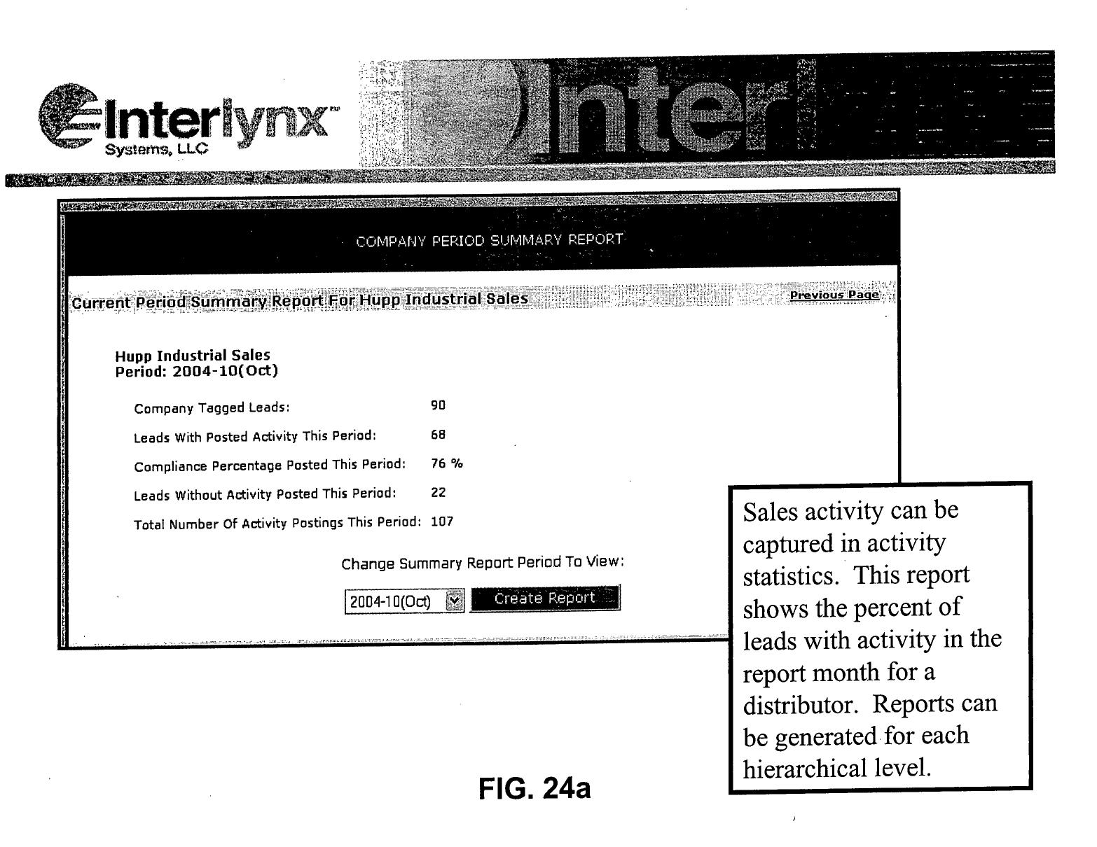

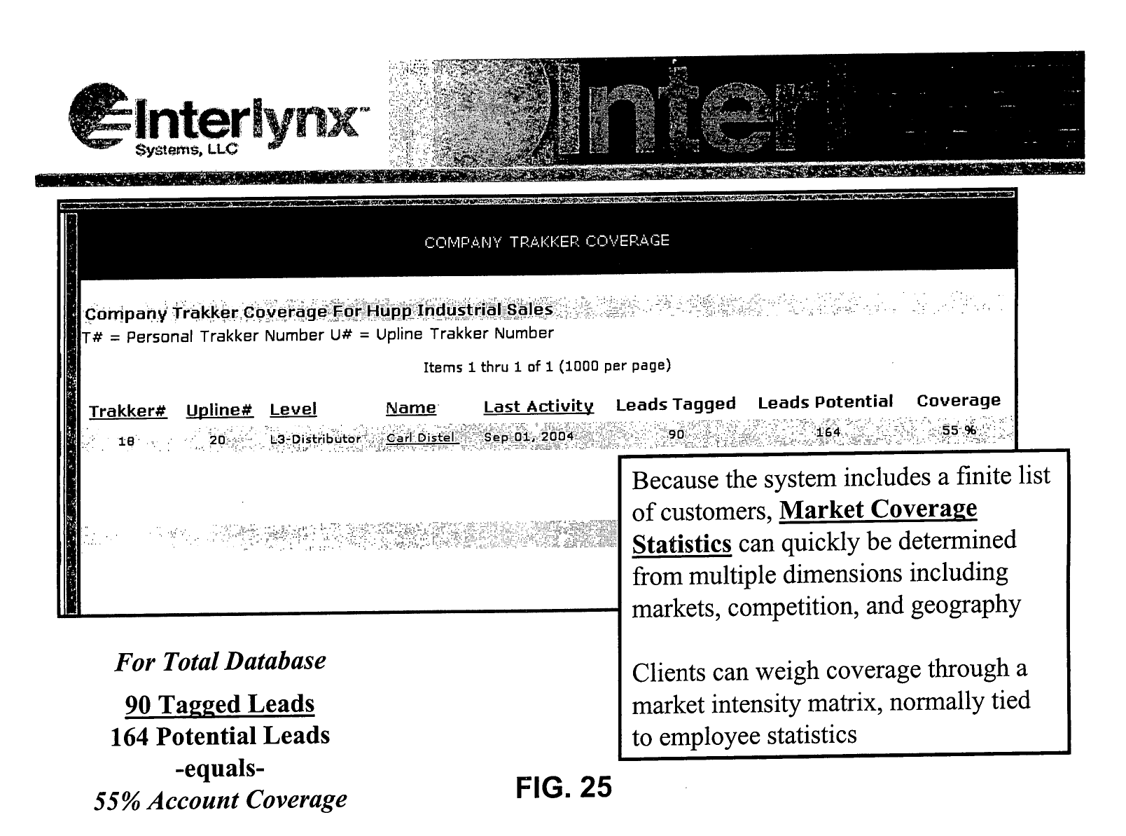

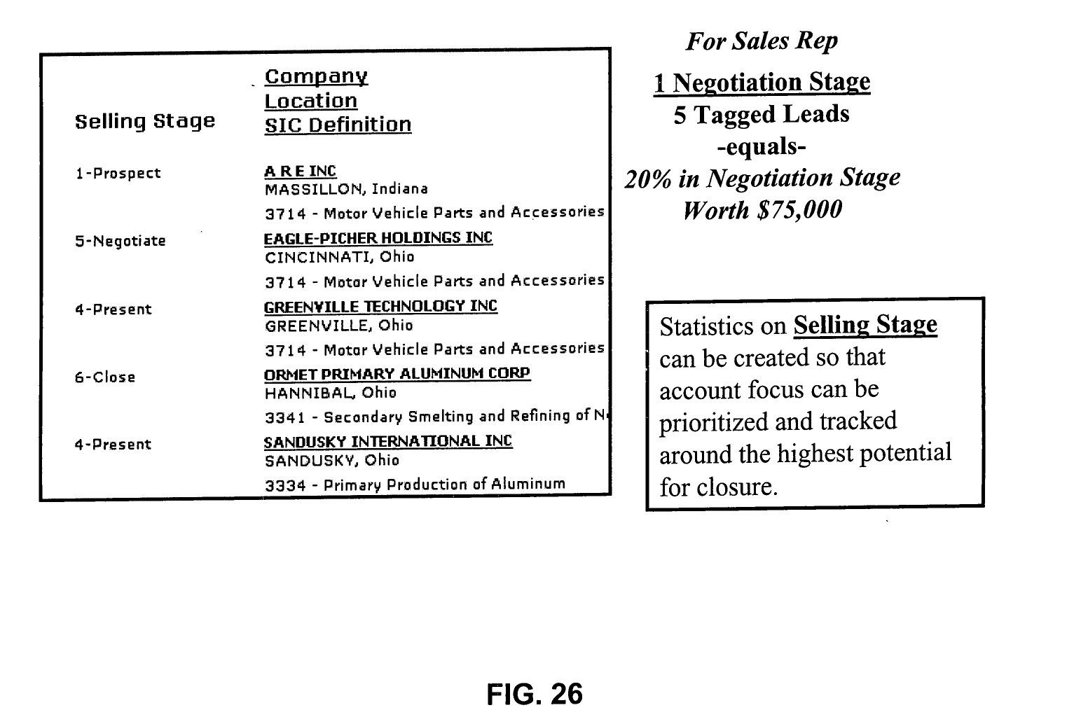

The user registration and information posting process facilitates the easy capture and organization of reports, which enhances the usability of the system. Information is captured in a database and reports can be created based on any number of parameters regarding information that has been captured (see FIG. 22). Using pre-defined fields allows for data to be easily sorted, organized, queried, and analyzed. Examples include: (a) market and sales activity of the representatives (see FIGS. 23, 24, and 24a); (b) market coverage statistics (see FIG. 25); (c) selling stage statistics (see FIG. 26); (d) competitive statistics by market, representative, industry, etc.; (e) lead follow through and ROI; (f) promotional hit rates; (g) representative performance; and (h) representative commitment.

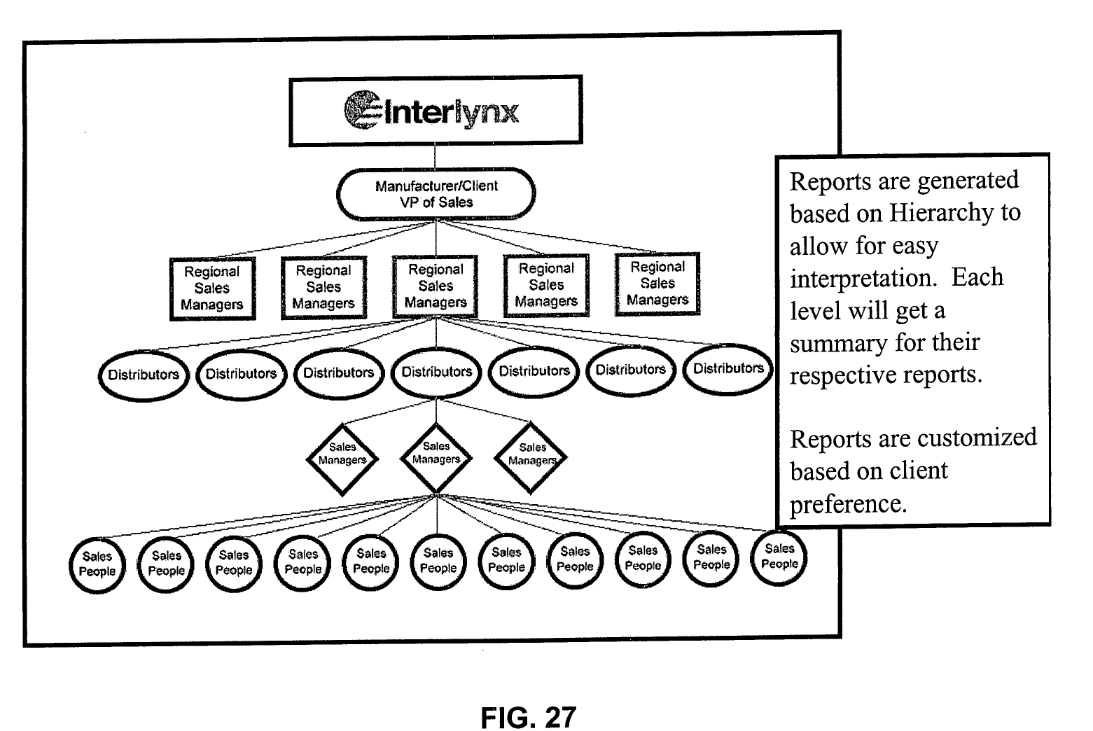

Because the system can incorporate a hierarchy, reports can be compiled on a hierarchical basis with differing levels of summaries and details possible (see FIG. 27). Representatives can be provided incentives through the reporting statistics. Points can be correlated with report statistics allowing for easy execution of incentives for the representative and its sales team. As points accumulate, they can be turned in for prizes, cash or other incentives. The system allows companies to know exactly who in the representative organization is working market activity. The use of incentives to motivate the representative may be especially beneficial when the representative carries competing lines or the company is not a major client of the representative. Incentives can be accessed via an on line catalog link through the program or by traditional means.

Additional system users include company representatives and representative teams. Other users from the company or representative agency could include members from management, sales personnel, principals, marketing, or any other user of information. Summary reports can be generated easily to provide concise but usable information that can be acted upon.

Those skilled in the art will recognize that the described system may be used to construct a MySQL Relational Database (or other relational database) for each record that includes the raw record, contact information, competitive information, sales potential, product potential, selling stage. Through the system, the record may then be linked to the client's sales hierarchy, so there is a clear linkage of accountability.

Assorted other beneficial aspects of various embodiments of the present invention comprise the following.
(1) The system drives accountability down the selling changes and as a result, positively drives the multiplier effect (8×8×6×4—see FIG. 1).
(2) System users who make representative or territory changes can more easily transfer information on activity since they are well documented. This helps to minimize disruptions during transition and assure continuity.
(3) When the system is used on the Internet, the information can be accessed globally and at any time. This provides improved ease of use. Also, this embodiment doesn't require resident software to be loaded on the user computers.
(4) The system may be used to link customers, distributors, sales personnel and direct sales efforts from different (and independently organized) SBUs on a single corporate database. The system, in this embodiment, may accommodate various selling models used by each entity with updates by SBU users, which would be recorded on the central data system. The central system may then be “mined” for market and customer information, which in turn may be leveraged into focused market and customer growth initiatives such as identification of common customers and industries served, cross divisional channel leverage opportunities, strategic account opportunities, identification of market based strategy opportunities, and identification of cross selling opportunities.
(5) A lead does not have to be a sales oriented function—the same structure may be used for other regular activity reporting—often handled through ad-hoc reports. This may be used, for example, for managing product design projects. The closed loop prompting and easy posting function may be used for things like new product development, scorecarding departments, etc.

Those skilled in the art will recognize that, by virtue of the present invention, clients are enabled to: (a) understand influence factors for their reps and distributors; (b) motivate their selling partners to drive higher activity levels; (c) establish a planning process that sets goals and accountability; (d) drive clarity and mutual expectations between parties; (e) monitor identification of and accountability for market opportunities; (f) establish clear metrics and score-carding systems; and (g) develop robust, interactive marketing databases.

While the present invention has been illustrated and described above regarding various embodiments, it is not intended to be limited to the details shown, since various modifications and structural changes may be made without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by letters patent is set forth in the appended claims.

1. A system for tracking lead information related to a representative selling network, comprising:
means for acquiring and storing lead data relating to leads of a representative selling network;
means for registration of a member of said representative selling network;
means for enabling said member to search, tag, or be assigned said lead data;
means for enabling said member to post activity data relating to said leads; and
means for preparing reports based on said lead data and said activity data.

2. A system as in claim 1, wherein said lead data is acquired from one or more of: company sources, representative sources, and third-party sources.

3. A system as in claim 1, wherein said registration is performed according to said member's position in a hierarchy governing said representative selling network.

4. A system as in claim 1, further comprising a means for rewarding said member for posting said activity data.

5. A system as in claim 1, wherein said means for tagging comprises means for associating said member with tagged lead data.

6. A system as in claim 1, wherein said searching comprises querying on multiple variables to look for potential or existing leads.

7. A system as in claim 4, wherein said rewarding comprises one or more of: lead protection, a special promotion, and a functional discount.

8. A system as in claim 1, further comprising one or more of: means for enabling collaboration among said member and one or more other members regarding multi-location leads; means for enabling collaboration among said member and one or more other members regarding project type leads; means for enabling sales lead management and prioritization; and means for enabling promotional support and streamlining.

9. A system as in claim 1, wherein said tagging comprises enhancing said lead data with one or more of: contact names, competition, potential, types of products used, and representative relationships.

10. A system as in claim 1, further comprising means for updating said lead data.

11. A system as in claim 1, further comprising means for reminding said member to post said activity data.

12. A system as in claim 1, further comprising means for enabling collaboration between members of a mixed selling network hierarchy.

13. A system as in claim 1, further comprising means for enabling collaboration between independent and company representatives.

14. A system as in claim 12, wherein said means for enabling collaboration is operable to enable collaboration based on local market conditions and approaches.

15. A system as in claim 1, wherein said reports comprise information relating to one or more of: market and customer coverage statistics, lead follow-through, hit rates of programs, representative performance, competitive information, and representative commitment.

16. A system as in claim 1, wherein said reports are based at least partially on said member's position in a hierarchy governing said representative selling network.

17. A system as in claim 1, wherein said means for enabling said member to post activity data comprises means for presenting pre-defined data entry fields for posting activity data.

18. A system as in claim 1, wherein said a first portion of lead data comprises one or more hyperlinks to a second portion of lead data.

19. A system as in claim 1, further comprising means for customizing commodity data to users or clients based on usage of said commodity data.

20. A system as in claim 11, wherein said means for reminding is part of a means for providing a closed loop process.
